(19) United States
(12) Patent Application Publication
(10) Pub. No.: US 2014/0351415 A1
(43) Pub. Date: Nov. 27, 2014

(54) SELECTIVE PACKET CAPTURE

(71) Applicant: PacketSled Inc., Del Mar, CA (US)

(72) Inventors: Matthew G. Harrigan, Del Mar, CA (US); Kurt Neumann, Del Mar, CA (US)

(73) Assignee: PACKETSLED INC., Del Mar, CA (US)

(21) Appl. No.: 13/902,519

(22) Filed: May 24, 2013

(51) Int. Cl. H04L 12/26

(52) U.S. Cl. CPC H04L 43/04
USPC 709/224

(57) ABSTRACT

Methods and systems for providing selective packet capture are described. One example method includes identifying a packet capture rule from a set of packet capture rules, the packet capture rule including a trigger condition and an action to perform when the trigger condition is detected; monitoring a network flow to detect whether the network flow satisfies the packet capture rule's trigger condition, wherein monitoring the network flow includes analyzing one or more packets included in the network flow to determine a set of protocol metadata associated with the network flow; and selectively performing the action associated with the packet capture rule on the network flow based on a result of the monitoring.

### FIELD

This specification generally relates to selective packet capture in a computer network.

### BACKGROUND

In enterprise and other computer networks, computers connected to an internal network may send data to destinations connected to wider, public networks such as the Internet. A network administrator, charged with overseeing the maintenance and security of a computer network, typically will monitor network traffic, either inbound or outbound or both, looking for undesirable or otherwise objectionable communications activity. One way to do so is to capture the individual packets that form a network flow and inspect their content.

### SUMMARY

In general, one aspect of the subject matter described in this specification may be embodied in systems and methods performed by data processing apparatuses that include the actions of identifying a packet capture rule from a set of packet capture rules, the packet capture rule including a trigger condition and an action to perform when the trigger condition is detected; monitoring a network flow to detect whether the network flow satisfies the packet capture rule's trigger condition, wherein monitoring the network flow includes analyzing one or more packets included in the network flow to determine a set of protocol metadata associated with the network flow; and selectively performing the action associated with the packet capture rule on the network flow based on a result of the monitoring.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example environment for enabling selective packet capture.

FIG. 2 is a message flow diagram of an example interaction between components of the example environment to perform selective packet capture.

FIG. 3 is a message flow diagram of an example interaction between components of the example environment when a full packet capture has been enabled for a network flow.

FIG. 4 is an example interface for a network monitoring application for performing selective packet capture.

FIG. 5 is an example interface for a network monitoring application for performing selective packet capture.

FIG. 6 is a flowchart of an example method for performing selective packet capture.

FIG. 7 is a diagram of computing devices that may be used to implement the systems and methods described in this document.

Like reference numbers and designations in the various drawings indicate like elements.

### DETAILED DESCRIPTION

In general, network owners desire to understand and, to the extent possible, control information sent over their networks. For example, a network owner may desire to maintain a forensic record of activity on the network in order to be able to investigate potential undesirable network activity at a later time. One possible approach is to capture and store all traffic sent over the network. On a network that includes more than a few nodes, however, the amount of data to be stored will quickly become unduly large, forcing the network owner to purchase hardware or contract for costly data storage. Accordingly, the present inventors recognized that a solution allowing a network owner to selectively capture only enough information to construct a reliable forensic record would be desirable.

In some implementations, the present solution allows the network owner to specify packet capture rules governing which portions of traffic on the network (e.g., which packets) will be captured and stored. In some implementations, the packet capture rules may specify that network flows associated with certain protocol metadata attributes should be captured. A network flow may be a connection between two or more endpoints on a network, a series of connections between the endpoints, an interaction between the endpoints including multiple connections or message sequences, or any other suitable network traffic. In some implementations, where network flows associated with a protocol metadata value, the solution may begin capturing network traffic (e.g., packets) associated with the network flow. In some cases, the solution may capture only certain packets or portions of certain packets as defined by the rule. The solution may also enable the full packet capture for the flow if specified by the rule, in which case all packets associated with the network flow will be stored for later analysis.

Examples of the solution in operation may be instructive. In one example, the solution may be configured with a rule stating that all network flows associated with a certain user should have full packet capture enabled. The solution may monitor network flows on the network and enable full packet capture on any flows where the protocol metadata includes login information matching the user. In another example, the solution may be configured to capture Structured Query Language (SQL) queries performed by a certain user. The solution may monitor each network flow and enable content extraction for SQL queries for any network flow with protocol metadata that includes login information matching the user. A wide variety of other variations of rules and their application are possible.

The present solution may provide several potential advantages. Storing only a portion of the data associated with the network flow may allow a network owner to allocate or contract for less storage for storing network data, leading to cost and space savings. Further, storing only network data deemed important or otherwise relevant by the network owner may simplify retrieving and analyzing the data at a later date. The solution may also provide increased flexibility by allowing a network owner to enable full packet capture or content extraction not only based on the content of individual packets but also based on protocol metadata values associated with the network flow.

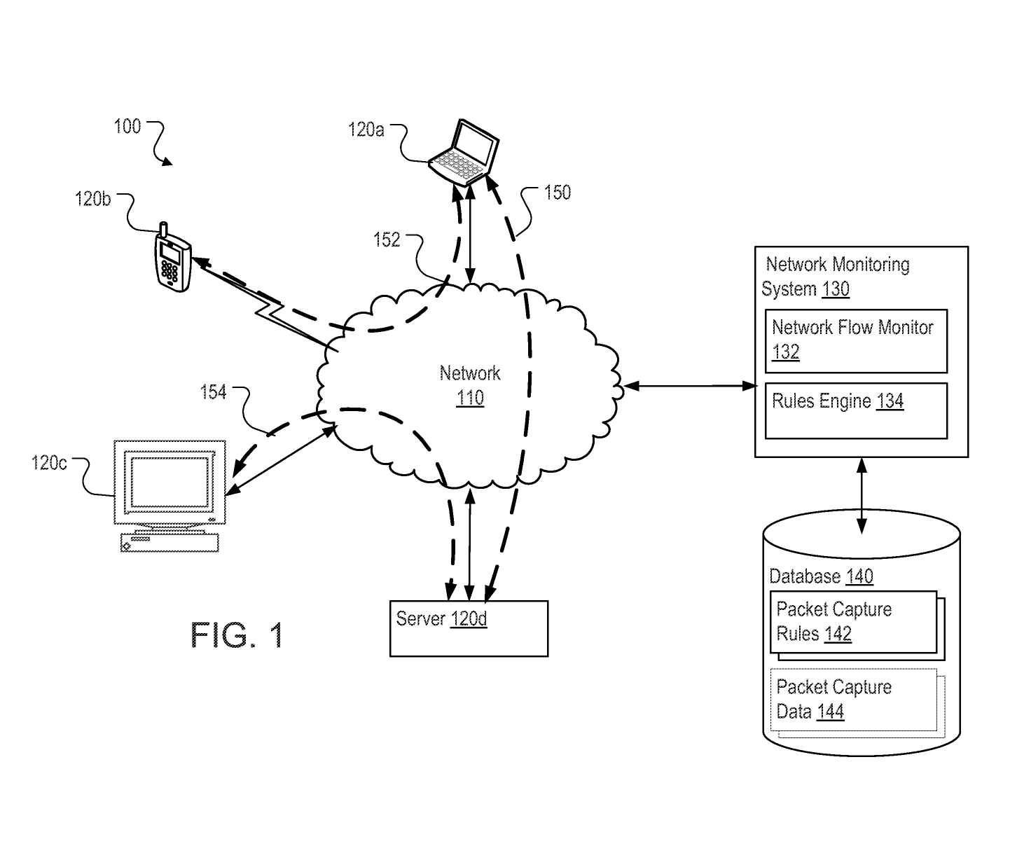

FIG. 1 shows an example environment 100 for enabling selective packet capture. The example environment 100 includes a plurality of devices 120a-d connected to a network 110. A network monitoring system 130 is also connected to the network 110. The network monitoring system 130 is connected to the database 140 including packet capture rules 142 for controlling the operation of the network monitoring system and packet capture data 144 representing packets captured during operation of the network monitoring system 130. The example environment 100 also includes one or more network flows 150, 152, 154 that represent network communication between the one or more devices 120a-d over the network 110.

In operation, the network monitoring system 130 monitors the network flows 150, 152, 154 over the network 110. In some implementations, the network monitoring system 130 may directly intercept and examine the packets that are sent as part of the network flows 150, 152, 154. The network monitoring system 130 may intercept the packets, analyze the packets to determine whether they should be captured, and forward the packets on to their intended destination. In some cases, the network monitoring system 130 may be deployed in a tap or span configuration, such that the packets that are part of the network flows 150, 152, 154 do not pass through the network monitoring system 130. In such a case, the network monitoring system 130 receives notification of the packets from another component within network 110.

The network monitoring system 130 consults a set of packet capture rules 142 stored in the database 140 to determine whether to capture packets belonging to the network flows 150, 152, 154. Each of the packet capture rules 142 include a trigger condition specifying a condition or set of conditions that, when met, will cause the associated actions specified in the rule to be performed. For example, a packet capture rule 142 may include a trigger condition indicating that the rule should be triggered for any flows including Session Initiation Protocol (SIP) messages. Each of the packet capture rules 142 may also include an action or set of actions to be performed when the trigger condition is detected. For example, a packet capture rule may include an action of enabling full packet capture on the network flow that triggered the rule. In some cases, the action or set of actions may also include extracting specific content from the network flow. For example, a rule associated with a SIP network flow may include the action of extracting control messages from the SIP network flow and storing those control messages while disregarding voice data associated with the flow.

The network monitoring system 130 may be configured to capture enough information from the network flows 150, 152, 154 that an accurate forensic record of each network flow may be stored. For example, in a scenario involving a network flow between a client and the database, it may be sufficient to store only the Structured Query Language (SQL) queries rather than storing the queries and the returned data sets. Because the content of the data sets may be inferred from the queries, a large amount of storage space may be saved by discarding the returned data set and only storing the queries.

As shown, the environment 100 includes devices 120a-d. The environment 100 also includes one or more devices 120a-d connected to internal network 110. In some implementations, the one or more devices 120a-d include mobile devices, such as cellular telephones (e.g., 120b), smartphones, tablets, laptops (e.g., 120a) and other similar computing devices. The one or more devices 120a-d may also include wired devices such as desktop computer 120c. In some implementations, the one or more devices 120a-d include personal devices associated with one or more users. The one or more devices 120a-d may also include devices issued or owned by the entity that provides the internal network 110, such as company-issued smartphones or laptops. In some implementations, the one or more devices 120a-d may run network access or web browsing software (e.g., a web browser) for accessing resources on the Internet 150. The one or more devices may also include servers connected to the internal network 110 (e.g., 120d).

As shown, the environment 100 includes an internal network 110. In some implementations, the internal network 110 may be a wireless or wired network provided by a corporation, educational institution, municipality, business, or other entity. Such a network may utilize any standard networking technology, including Ethernet, 802.11a, 802.11b, 802.11g, 802.11n, LTE, WiMax, CDMA, or any other suitable networking technology. In such implementations, the wireless network may be a public network in the sense that any device within range may connect to the network.

In the illustrated implementation, the environment 100 also includes a network monitoring system 130. In some implementations, the network monitoring system 130 may be a server or set of servers connected to the network 110 and configured to receive and analyze packets sent over the network 110. In some cases, the network monitoring system 130 may be a gateway between two networks included in the network 110, such that all packets sent from one network to the other pass through the network monitoring system 130. The network monitoring system 130 may also be deployed in a tap or span configuration, such that packets sent over the network 110 do not travel directly through the network monitoring system 130. Instead, in such a configuration, the network monitoring system 130 may receive a notification from another component in the network 110 informing it of packets sent on a network 110.

In some implementations, the network monitoring system 130 may be a computing device or a set of computing devices configured to perform the actions discussed above. In some cases, the network monitoring system 130 may be implemented as a combination of hardware and software. The network monitoring system 130 may also control or instruct other network components to perform any of the actions discussed herein.

The network monitoring system 130 may include a network flow monitor 132. In some implementations, the network flow monitor 132 may be a software or hardware component operable to detect and monitor network flows occurring on the network 110, such as network flows 150, 152, 154. In some cases, the network flow monitor 132 may analyze packets being sent across the network 110 and correlate these packets to the various network flows 150, 152, 154. For example, if a packet is sent from the laptop 120a to the server 120d, the network flow monitor 132 may classify this packet as belonging to network flow 150. In some implementations, the network flow monitor 132 may associate packets to flows based on information contained in the packets. For example, if a packet contains a session identifier or other identifier associating it with a communication between devices, the network flow monitor 132 may use this identifier to associate the packet with the network flow. In some cases, the network flow monitor 132 may associate packets to flows by examining networking attributes associated with the packets. For example, packets sent from a certain port on device 120a to a certain port on server 120d may be associated with network flow 150. In some implementations, the network flow monitor 132 may associate all packets sent between two devices with the same network flow.

As shown, the network monitoring system 130 also includes a rules engine 134. The rules engine 134 may be a software or hardware component operable to interpret and apply packet capture rules 142 to network traffic detected on network 110. In some implementations, the rules engine 134 reads the packet capture rules 142 from the database 140 and applies the packet capture rules 142 to the observed network traffic from network 110. For example, the rules engine 134 may determine that network flow 150 has triggered one of the packet capture rules 142. The rules engine 134 may also determine that the packet capture rule triggered by the network flow 150 specifies that a full packet capture be performed on the flow. In such a case, the rules engine 134 may enable full packet capture for the network flow 150, thus causing all packets associated with the network flow 150 to be stored in the database 140 as packet capture data 144. In some implementations, the rules engine 134 may instruct or control the network flow monitor 132 to capture the monitor packets. In some cases, the rules engine 134 may instruct or control another component inside or outside of the network monitoring system 130 and store the packets associated with the flow.

Rules engine 134 may also perform content extraction on the network flows based on the packet capture rules 142. For example, if network flow 150 includes SQL queries between the laptop 120a and the server 120d and one of the packet capture rules 142 specifies that the SQL query should be extracted from the network flow and stored, the rules engine 134 may perform this content extraction or cause another component to perform the content extraction.

In operation, the network monitoring system 130 and its associated components may enable a network owner to generate an accurate forensic record of network activity in different ways for different types of traffic. For example, a network owner may configure the network monitoring system 130 such that network flows using the Dynamic Host Configuration Protocol (DHCP) and/or the Domain Name Service (DNS) protocol will be described with metadata only, with no full packet capture or content extraction being performed. Such a configuration may be appropriate because the content of the protocol packets may be less important than the fact that the packets were sent. For example, the fact that a DNS request was sent from a client to a DNS server may be more important to the forensic record required by the network owner than the content of the packet.

In another example, a network owner may configure the network monitoring system 130 such that SQL flows (such as those involving MySQL or Oracle TNS) may only have metadata associated with the flow (e.g., login, password, SQL query, database) stored in the record. A network owner may also configure the network monitoring system 130 such that Server Message Block (SMB) network flows will have metadata (e.g, login, password, filename) and content from packets (e.g., file contents) stored in the record. In some cases, content extraction on the files in the SMB network flows may be performed only for network flows passing through a certain gateway machine. The extracted file content may then be analyzed according to data loss prevention (DLP) and malware detection techniques.

In another example, the network owner may configure the network monitoring system 130 such that network flows classified as using Secure Socket Layer encryption will have metadata and full packet capture enabled. In such a case, this configuration may be desirable because decryption and analysis of the packets may not be possible in real time, so the packets may be stored and analyzed at a later date.

In the illustrated example, the network monitoring system 130 is connected to a database 140. In some implementations, the database 140 is stored on the same server as the network monitoring system 130. The database 140 may also be stored on a separate server and accessed by the network monitoring system 130 over a network, such as network 110. The database 140 may be any proprietary or commercially available database system or format, including, but not limited to, MySQL®, Microsoft® SQLServer, IBM® DB2, Oracle®, SQLite, or any other suitable database system or format. The database 140 may also be a distributed database running on a plurality of servers. In some implementations, the database 140 may be a configuration file or set of configuration files associated with the network monitoring system 130. The network monitoring system 130 may examine these configuration files to determine the currently configured rules and associated actions.

As shown, the database 140 includes packet capture rules 142. In some implementations, the packet capture rules 142 are interpreted by the rules engine 134 and control the operation of the network monitoring system 130 in capturing and storing packets. Each packet capture rule may include a trigger condition and an action. Each trigger condition may specify a condition or set of conditions that, when detected, may cause the specified action to be performed. For example, a trigger condition may state that the network flow associated with a certain protocol metadata value should trigger the rule. Protocol metadata values may include attributes associated with the network flow, such as, for example, Hypertext Transfer Protocol (HTTP) headers, the source address, a destination address, login information, encryption keys, or any other suitable attributes.

Each of the packet capture rules 142 may also include an action or set of actions to be performed when the trigger condition is detected. In some implementations, the actions may include, but are not limited to, enabling full packet capture for the network flow, enabling full packet capture globally, performing content extraction on the network flow, or any other suitable action or set of actions.

The database 140 may also include packet capture data 144. In some implementations, the packet capture data 144 is stored in a table or set of tables and includes raw packets captured by the network monitoring system 130 according to the packet capture rules 142. In some cases, the packet capture data 144 may include a subset of the full packet data, such that the packets are parsed into fields and stored in a database table or set of tables. In some cases, the packet capture data may include timing information indicating when a packet was captured. In some cases, the signing information may allow a network analyst to replay a series of packets associated with the network flow using only the packet capture data 144.

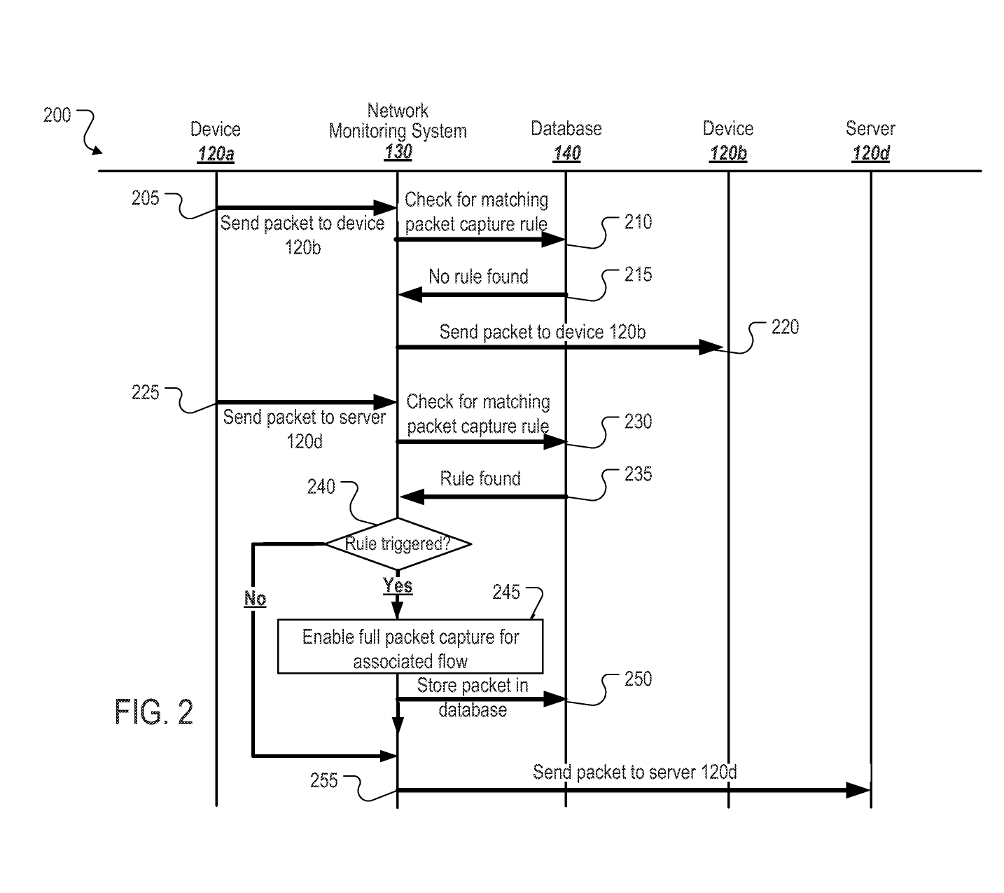

FIG. 2 is a message flow diagram of an example interaction 200 between the components of the example network to perform selective packet capture.

At 205, device 120a sends a packet to the device 120b over the network 110. In the illustrated implementation, the network monitoring system 130 receives the packet sent by the device 120a. In some implementations, such as a tap or span configuration, the network monitoring system 130 may not receive the packets sent by the device 120a but may instead receive a notification from another network component that the packet was sent.

At 210, the network monitoring system 130 checks the database for a matching packet capture rule for the packet sent at 205. In some implementations, the network monitoring system 130 may perform this check by sending an SQL query to the database 140 to select a matching packet capture rule from a table storing the rules.

At 215, the database 140 replies that no rule was found matching the packet. In some cases, the database 140 may reply that no rows were found in a table, indicating that no rule exists.

At 220, the network monitoring system 130 sends the packet originally sent by device 120a to device 120b. Implementations where the network monitoring system 130 is not in the data path of the network, and thus does not receive the packets directly, the network monitoring system 130 may not send the packet on to device 120b. Sending the packet to device 120b, in such cases, may be unnecessary because the packet has already been sent to device 120b, and the network monitoring system 130 is merely receiving an indication to that effect.

At 225, device 120a sends a packet to the server 120d. Again, the network monitoring system 130 receives the packet destined for server 120d. Again, in tap or span implementations, an indication of the packet would be received by the network monitoring system 130 instead of the packet itself.

At 230, the network monitoring system 130 again checks for a matching packet capture rule in the database 140. At 235, the database 140 responds that a matching rule was found. In some implementations, the network monitoring system 130 may query the database such that only rules that are triggered by the current packet and or flow may be returned at 235. In such a case, the decision at 240 would be omitted.

At 240, the rule is analyzed to determine whether it has been triggered by the packet sent at 225. In some implementations, this analysis may include examining the contents of the packet to determine whether the packet matches a trigger condition associated with a rule. The analysis may also include examining a network flow associated with the packet received at 225 to determine whether the network flow includes protocol metadata values matching the trigger condition for the rule. For example, if the packet is an HTTP GET message and the associated network flow includes an agent name attribute of “Mozilla”, a rule with a trigger condition applying to any network flow associated with the Mozilla browser would be triggered.

If the rule is triggered at 240, the message flow continues to 245, where the network monitoring system enables full packet capture for the flow associated with the packet. In some cases, the rule may specify a different action that enables full packet capture, such as performing content extraction. In such a case, the actions specified by the rule will be performed at 245.

At 250, the packet received at 225 is stored in the database. In some cases, where the rule specifies that content extraction should occur, only the portion of the packet specified by the content extraction rule may be stored in the database 140. For example, if a rule states that only HTTP headers for certain flow should be stored in the database, then the remaining portions of the HTTP packets would be discarded.

If the rule is not triggered at 240, the flow continues to 255, where the network monitoring system 130 sends the packet received at 225 to the server 120d. Note that after storing the packet in the database at 250, the network monitoring system also continues on and sends the packet to the server 120d at 255.

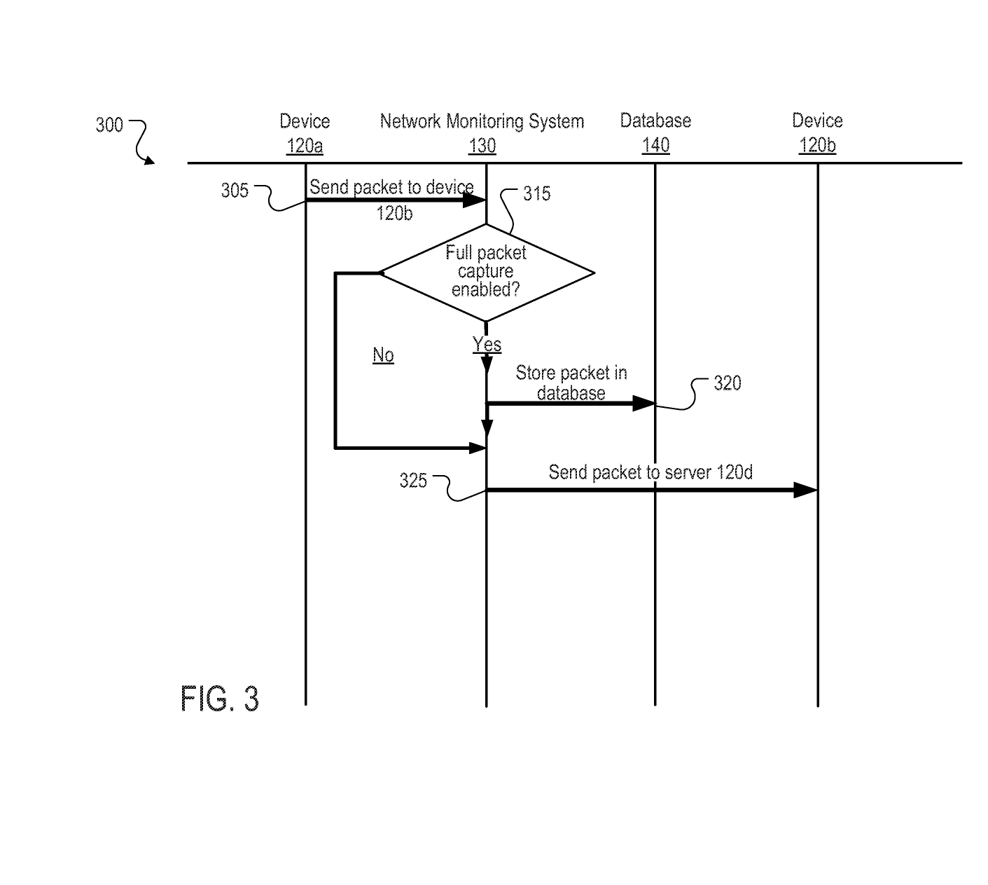

FIG. 3 is a message flow diagram of an example interaction 300 between the components of the example network when a full packet capture has been enabled for a network flow.

At 305, the device 120a sends a packet destined for device 120b over the network 110. The network monitoring system 130 receives the packet. In some implementations, as discussed previously, the network monitoring system 130 may receive only an indication of the packet and not the packet itself.

At 315, the network monitoring system 130 determines whether full packet captures are enabled for the network flow associated with the packet. In some implementations, the network monitoring system 130 queries the database 140 to determine if packet capture is enabled for the network flow associated with the packet. The network monitoring system 130 may also locally store indication of the network flows for which full packet captures are enabled and thus may not need to consult the database to make this decision.

If full packet capture is not enabled, the flow continues to 325, where the packet is sent to the device 120b. If full packet capture is enabled for the network flow associated with the packet, the flow continues to 320, where the packet is stored in the database 140. The flow then continues to 325 where the packet is sent to the device 120b.

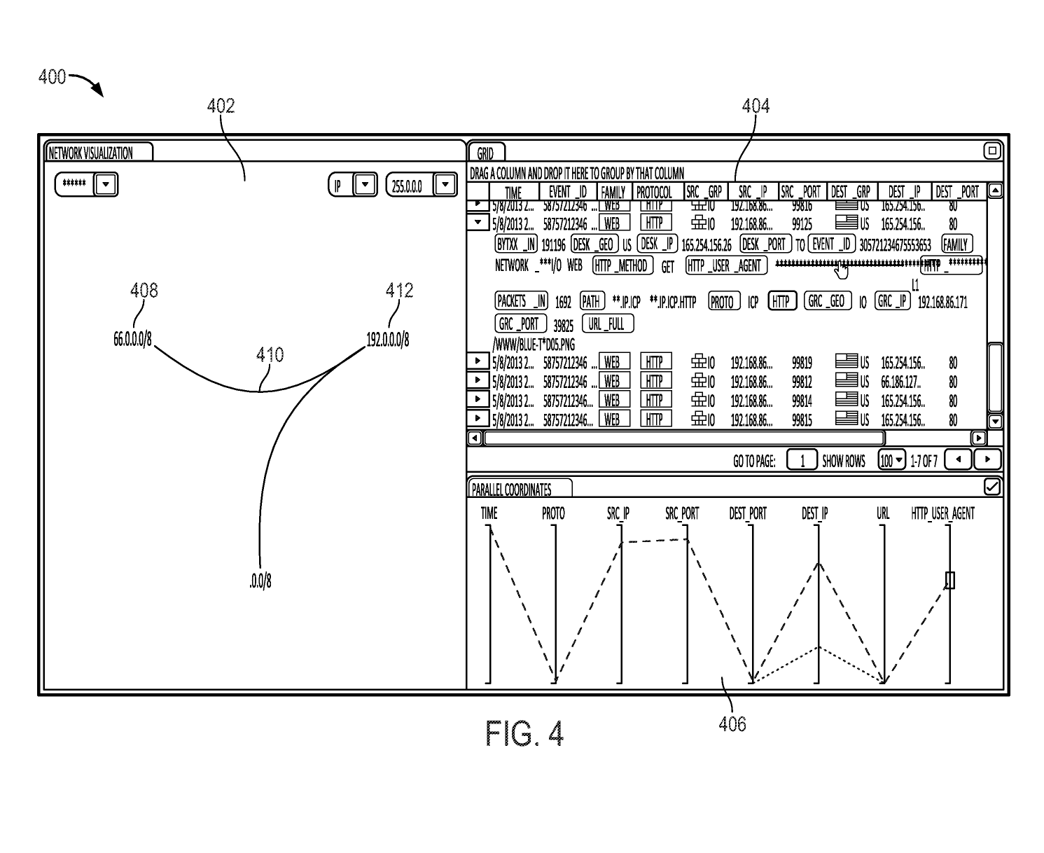

FIG. 4 is an example interface 400 for a network monitoring application for performing selective packet capture.

The interface 400 includes a network flow tab 402 providing a visual representation of detected network flows on a network. In the illustrated implementation, the network flow tab 402 includes a network flow 410 between two devices 408, 412. Each detected network flow is displayed as a curved line between two points representing the two devices involved in the flow. In some implementations, the devices may be identified by a network address, such as an Internet Protocol (IP) address. The example interface 400 also includes a flow attributes tab 404 providing information about the flows displayed in the network flow tab 402. In some implementations, the user may select the flow in the network flow tab 402 and examine various attribute about the flow in the flow attributes tab 404. In some cases, the network flow tab 402 and flow attributes tab 404 may be used to configure the selected packet capture functionality described relative to FIG. 1. For example, the user may specify protocol metadata values associated with the flow in the flow attributes tab and may configure full packet capture, content extraction, or another action to occur based on those protocol metadata values.

The example interface 400 also includes a parallel coordinates tab 406 that displays a parallel coordinates visualization of network flows selected in the network flow tab 402. This visualization functionality is described in greater detail in co-pending application Ser. No. ______, filed ______, which is hereby incorporated by reference.

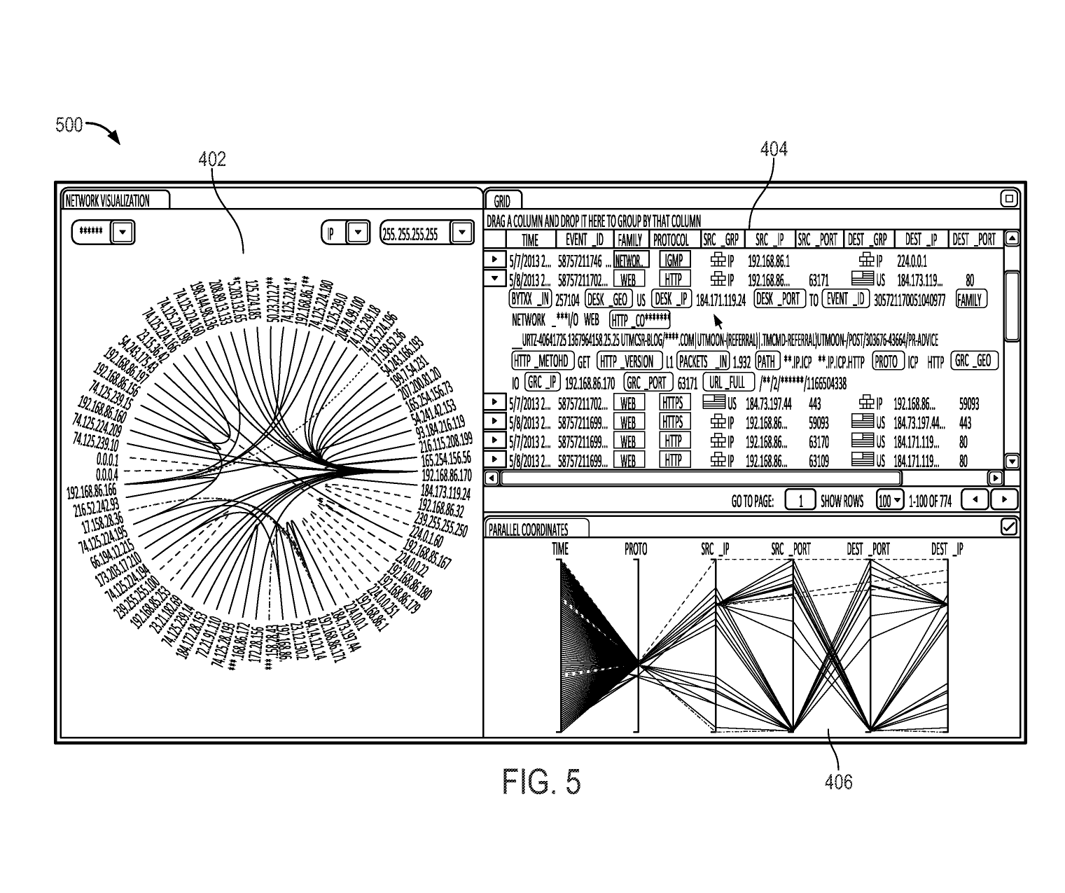

FIG. 5 is an example interface 500 for a network monitoring application for performing selective packet capture. The example interface 500 includes the network flow tab 402, the flow attributes tab 404, and the parallel coordinates tab 406 described relative to FIG. 4. In the example interface 500, the network flow tab 402 is illustrated as showing a plurality of network flows, each represented by a curved line between two points. In some implementations, each curved line representing a network flow may indicate an attribute of the flow by its color. For example, an HTTP flow may be depicted as a pink curved line, while an SQL flow may be depicted as a blue curved line.

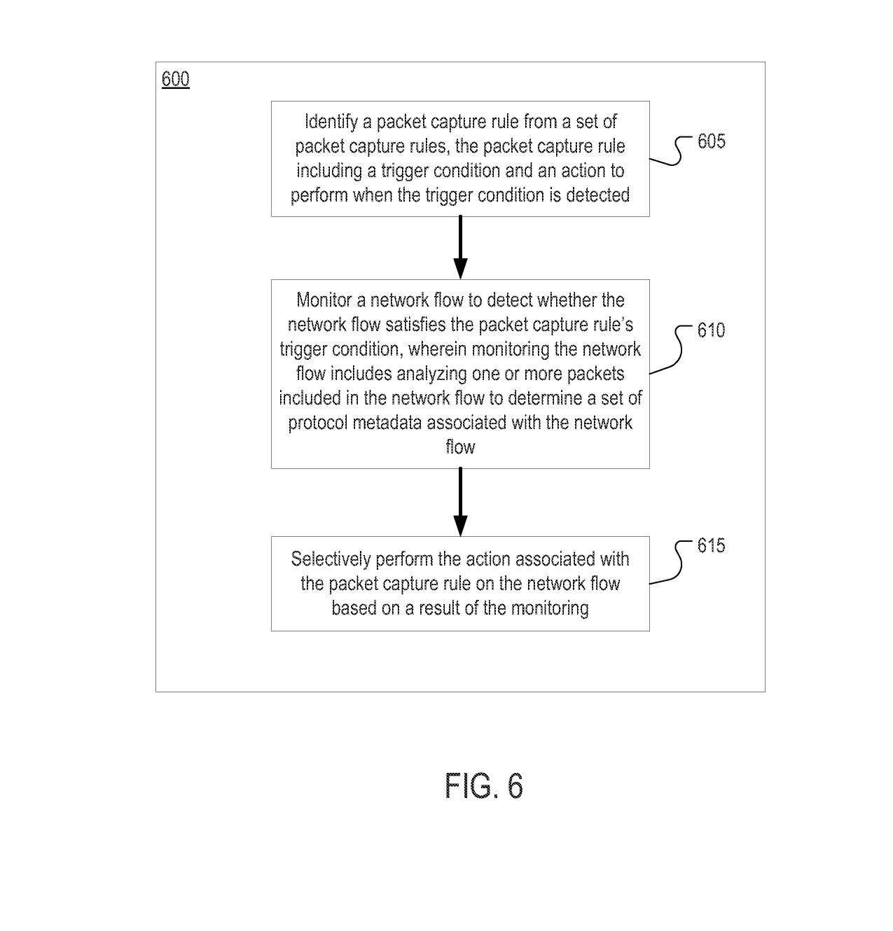

FIG. 6 is a flowchart of an example method 600 for performing selective packet capture. At 605, a packet capture rule is identified from a set of packet capture rules, the packet capture rule including a trigger condition and an action to perform when the trigger condition is detected. As discussed previously relative to FIG. 1, the packet capture rule may be stored in a database (e.g., 140), and may be identified by submitting an SQL query to the database. The trigger conditions and actions may include any of the attributes discussed relative to FIG. 1.

At 610, a network flow is monitored to detect whether the network flow satisfies the packet capture rules trigger condition, wherein monitoring the network flow includes analyzing one or more packets included in the network flow to determine a set of protocol metadata associated with the network flow. As previously discussed, the protocol metadata may include attributes associated with the network flow, such as a protocol, the source address, a destination address, login information, encryption keys, session identifiers, HTTP or other headers, or any other suitable value. Monitoring the network flow may also include examining the content of the one or more packets to determine whether the content satisfies the trigger condition associated with a rule. For example, the trigger condition may apply to packets containing SQL SELECT queries. In such a case, a packet containing SQL SELECT query would trigger the associate rule.

At 615, the action associated with the packet capture rules is selectively performed on the network flow based on a result of the monitoring. In some implementations, if the true condition is detected during monitoring, the action may be performed. In some cases, the action may include a set of multiple actions to be performed on the network flow. The action may include any of the actions discussed relative to FIG. 1.

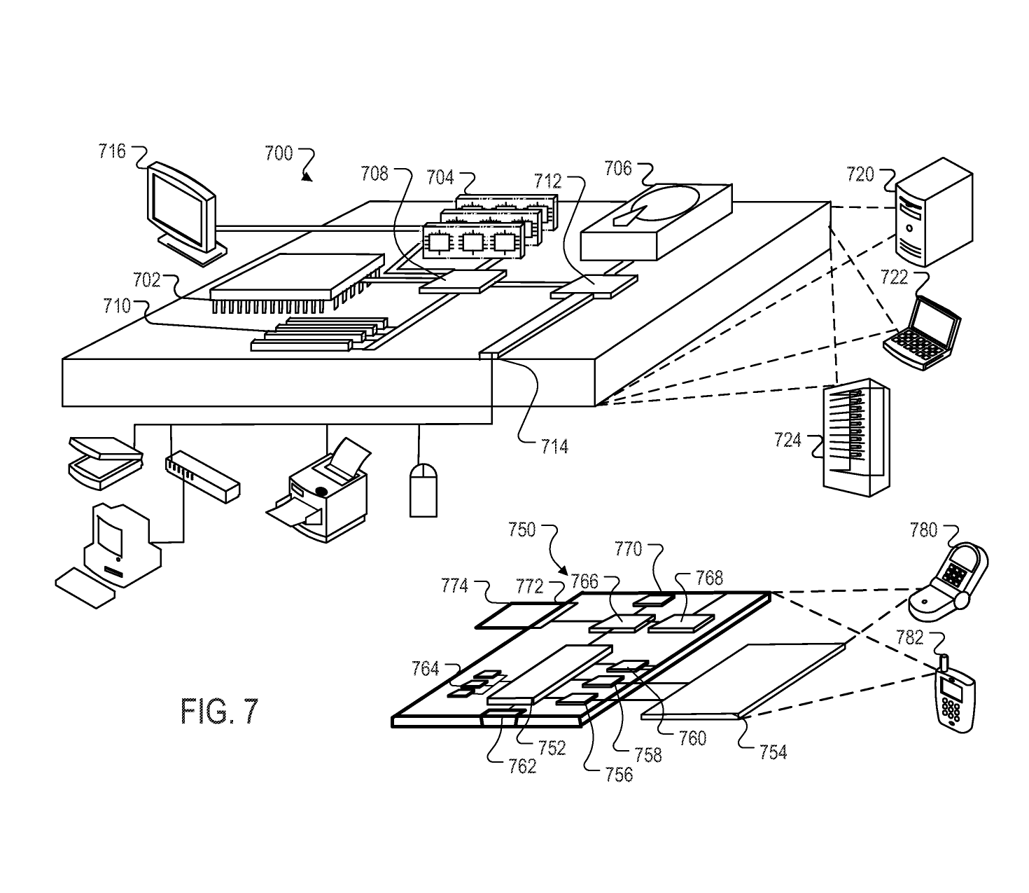

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. Additionally computing device 700 or 750 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only and are not meant to limit implementations of the inventions described and/or claimed in this document.

Computing device 700 includes a processor 702, a memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed interface 708 manages bandwidth-intensive operations for the computing device 700, while the low speed interface 712 manages lower bandwidth-intensive operations. Such allocation of functions is exemplary only. In one implementation, the high-speed interface 708 is coupled to memory 704, display 716 (e.g., through a graphics processor or accelerator), and to high-speed expansion ports 710, which may accept various expansion cards (not shown). In the implementation, low-speed interface 712 is coupled to storage device 706 and low-speed bus 714. The low-speed bus, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer, such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device to provide additional storage. Each of the components 750, 752, 764, 754, 766, and 768, are interconnected using various buses and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. Additionally, the processor may be implemented using any of a number of architectures. For example, the processor 752 may be a CISC (Complex Instruction Set Computers) processor, a RISC (Reduced Instruction Set Computer) processor, or an MISC (Minimal Instruction Set Computer) processor. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations or for wireless communication in other implementations and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user, as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front-end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method executed by one or more processors, the method comprising:
identifying a packet capture rule from a set of packet capture rules, the packet capture rule including a trigger condition and an action to perform when the trigger condition is detected;
monitoring a network flow to detect whether the network flow satisfies the packet capture rule's trigger condition, wherein monitoring the network flow includes analyzing one or more packets included in the network flow to determine a set of protocol metadata associated with the network flow; and
selectively performing the action associated with the packet capture rule on the network flow based on a result of the monitoring.

2. The method of claim 1 wherein monitoring the network flow comprises detecting that the network flow satisfies the packet capture rule's trigger condition, and wherein selectively performing the action comprises performing the action associated with the packet capture rule upon detecting that the network flow satisfies the packet capture rule's trigger condition.

3. The method of claim 1, wherein the trigger condition specifies one or more protocol metadata values, and detecting the trigger condition includes detecting that the one or more protocol metadata values are included in the set of protocol metadata associated with the network flow.

4. The method of claim 1, wherein the trigger condition specifies one or more content values, and detecting the trigger condition includes detecting the one or more content values within the one or more packets associated with the network flow.

5. The method of claim 1, wherein the action to perform when the trigger condition is detected includes enabling a full packet capture, and performing the action includes enabling a full packet capture.

6. The method of claim 5, wherein enabling the full packet capture on the network flow includes storing the one or more packets.

7. The method of claim 1, wherein the action to perform when the trigger condition is detected includes enabling content extraction, and performing the action includes extracting at least part of the one or more packets included in the network flow.

8. The method of claim 1, further comprising:
determining that the network flow is an encrypted network flow;
enabling full packet capture for the network flow upon determining that the network flow is the encrypted network flow;

9. The method of claim 1, further comprising:
determining that the network flow is associated with an unknown protocol;
enabling full packet capture for the network flow upon determining that the network flow is associated with the unknown protocol;

10. The method of claim 1, further comprising:
determining that the network flow is associated with the at least one of: Dynamic Host Configuration Protocol (DHCP), or Domain Name Service (DNS) protocol;
storing protocol metadata values for the network flow.

11. The method of claim 1, further comprising:
determining that the network flow is associated with the at least one of: MySQL, or Transparent Network Substrate (TNS) protocol;
storing protocol metadata values for the network flow.

12. The method of claim 1, further comprising:
determining that the network flow is associated with the Server Message Block (SMB) protocol;
storing protocol metadata values for the network flow;
performing content extraction on one or more files transferred during the network flow; and
storing the content extracted from the one or more files.

13. The method of claim 1, further comprising:
determining that the network flow is associated with at least one of: the Secure Socket Layer (SSL) protocol, or the Transport Layer Security (TLS) protocol; and
performing full packet capture on the network flow.

14. A system comprising:
a processor configured to execute computer program instructions; and
a computer storage medium encoded with computer program instructions that, when executed by the processor, cause the system to perform operations comprising:
identifying a packet capture rule from a set of packet capture rules, the packet capture rule including a trigger condition and an action to perform when the trigger condition is detected;
monitoring a network flow to detect whether the network flow satisfies the packet capture rule's trigger condition, wherein monitoring the network flow includes analyzing one or more packets included in the network flow to determine a set of protocol metadata associated with the network flow; and
selectively performing the action associated with the packet capture rule on the network flow based on a result of the monitoring.

15. The system of claim 14, wherein monitoring the network flow comprises detecting that the network flow satisfies the packet capture rule's trigger condition, and wherein selectively performing the action comprises performing the action associated with the packet capture rule upon detecting that the network flow satisfies the packet capture rule's trigger condition.

16. The system of claim 14, wherein the trigger condition specifies one or more protocol metadata values, and detecting the trigger condition includes detecting that the one or more protocol metadata values are included in the set of protocol metadata associated with the network flow.

17. The system of claim 14, wherein the trigger condition specifies one or more content values, and detecting the trigger condition includes detecting the one or more content values within the one or more packets associated with the network flow.

18. The system of claim 14, wherein the action to perform when the trigger condition is detected includes enabling a full packet capture, and performing the action includes enabling a full packet capture.

19. The system of claim 18, wherein enabling the full packet capture on the network flow includes storing the one or more packets.

20. A computer-implemented method executed by one or more processors, the method comprising:
identifying a packet capture rule from a set of packet capture rules, the packet capture rule including a trigger condition and an action to perform when the trigger condition is detected, the trigger condition including at least one of: one or more protocol metadata values, or one or more content values, the action including at least one of: enabling a full packet capture, or enabling content extraction;
monitoring a network flow to detect whether the network flow satisfies the packet capture rule's trigger condition, monitoring the network flow including analyzing one or more packets included in the network flow to determine a set of protocol metadata associated with the network flow; and
selectively performing the action associated with the packet capture rule on the network flow based on a result of the monitoring, performing the action including at least one of:
extracting at least part of the one or more packets included in the network flow; or
storing the one or more packets associated with the network flow.
